(19) United States
(12) Patent Application Publication
(10) Pub. No.: US 2023/0222275 A1
(43) Pub. Date: Jul. 13, 2023

(54) Systems And Methods For Correcting Errors in Code For Circuit Designs

(71) Applicant: Intel Corporation, Santa Clara, CA (US)

(72) Inventors: Gregg Baeckler, San Jose, CA (US); Mahesh A. Iyer, Fremont, CA (US); Martin Langhammer, Salisbury (GB)

(73) Assignee: Intel Corporation, Santa Clara, CA (US)

(21) Appl. No.: 18/122,612

(22) Filed: Mar. 16, 2023

(51) Int. Cl. G06F 30/327

(52) U.S. Cl. CPC G06F 30/327; G06F 2111/04

(57) ABSTRACT

A method is provided for processing code for a circuit design for an integrated circuit using a computer system. The method includes receiving at least a portion of the code for the circuit design for the integrated circuit, wherein the portion of the code comprises an error or has incomplete constraints, making an assumption about the error and the missing constraints using a computer aid design tool, and generating a revised circuit design for the integrated circuit with the error corrected and any missing constraints added based on the assumption and based on the code using the computer aided design tool and a library of components for circuit designs.

### TECHNICAL FIELD

The present disclosure relates to electronic systems, and more particularly, to systems and methods for correcting errors in code for circuit designs.

### BACKGROUND ART

Configurable logic integrated circuits can be configured by users to implement desired custom logic functions. In a typical scenario, a logic designer uses computer-aided design (CAD) tools to design a custom circuit design. When the design process is complete, the computer-aided design tools generate configuration data. The configuration data is then loaded into configuration memory elements that configure configurable logic circuits in the integrated circuit to perform the functions of the custom circuit design. Configurable logic integrated circuits can be used for co-processing in big-data or fast-data applications. For example, configurable logic integrated circuits may be used in application acceleration tasks in a datacenter and may be reprogrammed during datacenter operation to perform different tasks.

### BRIEF DESCRIPTION OF DRAWINGS

FIG. 1 is a diagram that illustrates an example of a graphical user interface (GUI) that allows a user to select a portion of the code for a circuit design for an integrated circuit (IC) to be synthesized to the IC.

FIG. 2 depicts a flow chart that illustrates examples of operations that can be performed to synthesize a subset of the code for a portion of a circuit design for an IC.

FIG. 3 illustrates an example of a programmable IC that can implement techniques disclosed herein, according to an embodiment.

FIG. 4 is a diagram showing how configuration data is created by a logic design system and loaded into a programmable logic integrated circuit (IC) to configure the IC for operation in a system in accordance with an embodiment.

FIG. 5 is a diagram of a circuit design system that can be used to design integrated circuits in accordance with an embodiment.

FIG. 6 is a diagram of illustrative computer-aided design (CAD) tools that can be used in a circuit design system in accordance with an embodiment.

### DETAILED DESCRIPTION

The process of mapping a circuit design to a configurable integrated circuit using computer-aided design tools may yield poor quality results in terms of circuit area and performance if the process is not coded by an expert logic designer. Yielding high quality results in terms of circuit area and performance often requires substantial expertise, because the mapping of a register transfer level (RTL) of a circuit design to the programmable logic resources of a configurable integrated circuit is typically not intuitive. Previously known CAD tools require that the RTL of an entire circuit design be synthesized to the programmable logic resources of a configurable integrated circuit at once.

According to various embodiments disclosed herein, systems and methods are provided for synthesizing only a portion (i.e., a subset) of the code for a circuit design to the logic resources of an integrated circuit, such as a configurable integrated circuit (IC). Initially, a computer system running a CAD tool can provide an option for a user to select a portion of the code for a circuit design for an IC. The portion of the code selected by the user can be any percentage of the total code for the circuit design (e.g., a small or large percentage of code). The computer system can determine if the portion of the code has an error, make an assumption about the error, and correct the error in the code based on the assumption using the CAD tool. The computer system can identify errors of omission in the code (e.g., missing variable declarations) and errors of commission in the code (e.g., code with incorrect syntax). The computer system can estimate any changes that are needed for legality, including for example, filling in the variable declarations from the rest of the context of the code. The computer system then performs a technology mapping to parse the portion of the code selected by the user. The computer system then synthesizes, clusters and packs, and places and routes the portion of the code selected by the user into an approximation of the architecture of the IC. These steps can, for example, be performed by the computer system quickly (e.g., in seconds).

The computer system running the CAD tool can, for example, quickly map any subset of a circuit design to an IC, such as a configurable IC. The computer system running the CAD tool can also create a component of a clustered and packed subset of logic so that the user can determine the characteristics of the circuit design during the design phase. The computer system running the CAD tool can, for example, provide very fast, informal compiles, including reasonably accurate place and route behaviors of a circuit design for an IC (e.g., that can be modelled in seconds). A user can, for example, map a portion of a circuit design to an IC many times (e.g., hundreds of times a day) to generate mappings of the circuit design that provide a reasonable estimation of the progress of the circuit design.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

According to some examples disclosed herein, a computer system running a CAD tool generates a graphical user interface (GUI) that provides a user with an option to select a portion of the code for a circuit design for an integrated circuit (IC) to be synthesized to the logic resources of the IC. The GUI can, for example, invoke synthesis and place and route algorithms that are designed to synthesize, place, and route a portion of a circuit design to the architecture of the IC, such as a configurable IC. By allowing a user to select and synthesize only a portion of the code for a circuit design for an IC, the CAD tool can allow the user to substantially improve the quality and the performance of the code, which is especially beneficial for users that do not have expertise with a particular IC architecture.

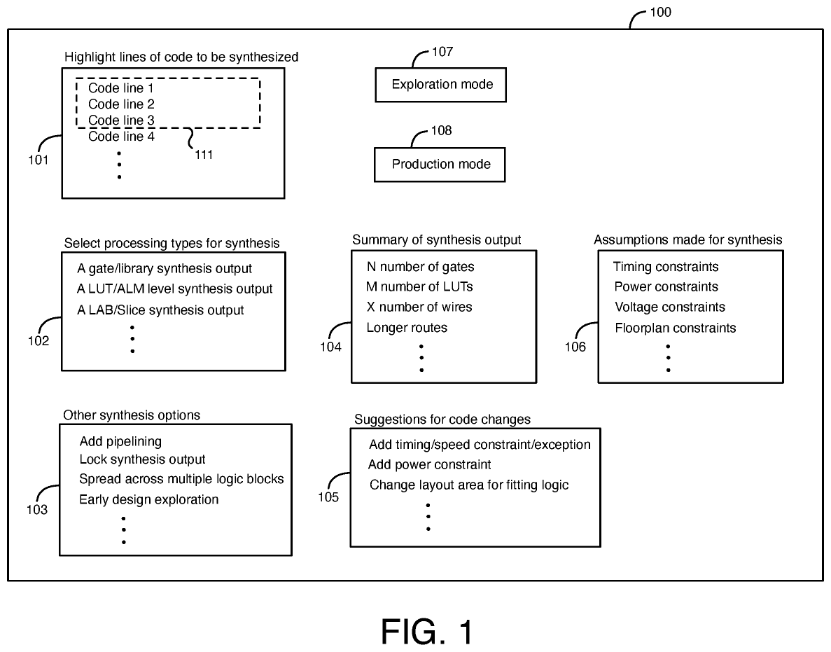

FIG. 1 is a diagram that illustrates an example of a graphical user interface (GUI) 100 that allows a user to select a portion of the code for a circuit design for an integrated circuit (IC) to be synthesized to the IC. A computer aided design (CAD) tool (also referred to herein as an electronic design automation tool) running on a computer system can generate the GUI 100 shown in FIG. 1. The GUI 100 of FIG. 1 provides a user with an option to select one or more lines of code (i.e., software code) for a circuit design for an IC that is to be synthesized to the IC.

GUI 100 includes an interface 101 that displays some or all of the code (e.g., from an RTL file) that characterizes the circuit design for the IC. The code for the circuit design can be written in any suitable hardware description language (HDL), such as Verilog or VHDL. In some examples, the code in interface 101 can include expressions that are written in 2 different HDLs (e.g., some expressions in Verilog and some expressions in VHDL). The CAD tool creates an interface 101 in GUI 100 that allows the user to select any HDL code displayed in the interface 101. Interface 101 can be created within GUI 100 as shown in FIG. 1 or in a separate window. As an example, the user can select code lines 1, 2, and 3, as illustrated by the dotted box 111 in FIG. 1. As a more specific example, the user can highlight the code in lines 1-3 shown in box 111 with a mouse click.

The GUI 100 can also generate an interface 102 that provides the user with an option to select among various processing types for synthesizing the lines of HDL code selected in interface 101. The interface 102 can provide the user with the option to select among various processing types for the synthesis, for example, by providing radio buttons, multi-option fields, and/or the option to highlight one or more of the processing types. Interface 102 in FIG. 1 shows various processing types that are provided as examples and are not intended to be limiting. The examples of the processing types for the synthesis shown in interface 102 include a gate and/or library synthesis output, a lookup table (LUT) and/or adaptive logic module (ALM) level synthesis output, and/or a logic array block (LAB) and/or logic circuit slice level synthesis output. The options to select LUT, ALM, and LAB synthesis outputs can be provided if the IC is a configurable IC, such as a field programmable gate array (FPGA).

According to another example, the CAD tool can display another interface 103 in GUI 100 that provides a user with other synthesis options. For example, the CAD tool can provide the user with a selectable option in interface 103 for adding pipelining to the lines of HDL code selected in interface 101. The pipelining can be added to the HDL code by a synthesis tool, even if pipelining is not coded in the lines of HDL code selected by the user in interface 101. In addition, interface 103 can allow the user to select the number of levels of pipelining to be added to the HDL code. As another example, the computer system can provide an optional feature that the pipelining selected by the user can be coded by the synthesis tool, and the pipelined code can be added back into the HDL code for the circuit design.

As another example, the CAD tool can provide the user with a selectable option in interface 103 for locking the synthesis output generated from the lines of HDL code selected in interface 101. If the user selects the lock synthesis output in interface 103, the synthesis tool locks the entire HDL code selected in interface 101 into logic blocks (e.g., LAB structures) selected by the synthesis tool that can be, for example, shown in an immediate synthesis window. The CAD tool can also add an exclusive option to this locking process, which prevents any other HDL code from being placed into the selected logic blocks (e.g., LABs). The generated logic blocks are all relationally placed in the synthesis output, which means that the logic blocks can be moved around by the system-level place and route tool. This option to lock the synthesis output can help the user understand the impact of the circuit design, and compare different approaches to using the logic resources of the IC (e.g., an array of configurable logic in a configurable IC).

In response to receiving selections from the user in interfaces 101-103, the synthesis tool (e.g., that is part of the CAD tool) performs a synthesis operation on only the one or more lines of HDL code selected by the user in interface 101 to the logic resources of the IC based on the synthesis options selected in interfaces 102-103 to generate a gate-level netlist. The CAD tool then provides an output of the synthesis operation to the user based on the processing type selected in interface 102 and the other options selected in interface 103, as disclosed in further detail below, based on the gate-level netlist.

The output of the synthesis operation (i.e., the synthesis output) provided by the CAD tool can include, for example, a LAB level output that is the synthesis of the lines of HDL code selected by the user in interface 101 into one or more logic array blocks (LABs) in the IC, if the LAB option is selected in interface 102. The synthesis output can, for example, be shown in a GUI, such as GUI 100. The GUI can display information from the synthesis output, such as the number of routes in and out of the LAB that the lines of HDL code selected in interface 101 are synthesized to. The GUI can also display the number of routes left for both directions in and out of the LAB. As a specific example that is not intended to be limiting, the GUI can use different colors to highlight the routing in the synthesis output (e.g., green for lightly loaded routing, yellow for heavily loaded routing, and red for saturated or near saturated routing).

After the synthesis tool performs the synthesis of the lines of HDL code selected in interface 101, the CAD tool can display an interface 104 in GUI 100 (e.g., in response to a mouse click) that shows a summary of the synthesis output. The summary shown in interface 104 can, for example, enumerate the number of logic gates, the number of configurable circuits (e.g., lookup tables (LUTs)), and the number of wires in the synthesis output. The summary shown in interface 104 can also, for example, show the longer routes required if the gate-level netlist generated for the lines of HDL code selected in interface 101 spans across several LABs in the IC.

The CAD tool can also display additional information in additional interfaces. For example, the CAD tool can display the assumptions made by the synthesis tool in an interface 106, such as assumptions made about timing, power, voltage, and floorplan constraints, especially if the lines of HDL code selected in interface 101 are context free (e.g., have undefined variable declarations).

The synthesis tool can, for example, make assumptions about the structure of the HDL code that is selected by the user in interface 101 and can generate new HDL code that implements the assumptions about the structure. The synthesis tool can then use this new HDL code and the HDL code selected in interface 101 to generate the gate-level netlist. The CAD tool can also display an explicit version of the new HDL code that the synthesis tool has generated and used to generate the gate-level netlist. The explicit version of the new HDL code can be cut and pasted by the user back into the user's HDL code for the circuit design, for example, if the synthesis tool has corrected a syntax error or created better quality HDL code.

According to additional examples, the CAD tool (e.g., the synthesis tool) disclosed herein can perform implied legality functions with respect to errors of omission and/or errors of commission in the HDL code that is selected by the user for synthesis (e.g., in interface 101). In these examples, the synthesis tool initially assumes that the HDL code selected by the user (e.g., in interface 101) is legal and can be parsed to perform synthesis without synthesizing the HDL code for the entire circuit design. In contrast to performing synthesis on an entire circuit design (or component), the subset of the HDL code selected by the user (e.g., in interface 101) may be missing a significant amount of information, such as, but not limited to, input and output ports, variable declarations, and instantiations of other components in the circuit design. Thus, the code may contain errors of omission. In these examples, the synthesis tool attempts to correct the errors of omission by finding the most likely values for any information missing from the HDL code selected by the user. Any assumptions that the synthesis tool makes regarding information missing from the HDL code selected by the user is reported in GUI 100, so that the user can correlate these assumptions with the user's intentions.

In other examples, the subset of the HDL code selected by the user (e.g., in interface 101) may have errors of commission, such as lines of code containing syntax errors that violate the syntax rules of the HDL. In these examples, the synthesis tool attempts to correct any errors of commission in the HDL code selected by the user, such as syntax rule violations.

As an example of an implied legality function, the CAD tool can apply a rule for implied input ports in the HDL code selected by the user for synthesis (e.g., in interface 101). According to this rule, if the HDL code selected by the user refers to a signal (e.g., out=a & b), but the signal does not otherwise exist in the HDL code selected by the user, the CAD tool assumes that the signal is provided to the circuit defined by the selected HDL code as a primary input. The implied legality function performed by the CAD tool disclosed herein for implied input ports is different than the traditional behavior of a previously known CAD tool that would report an error for any signal that is not driven by a source.

As another example of an implied legality function, the CAD tool can apply a rule for implied output ports in the HDL code selected by the user for synthesis (e.g., in interface 101). According to this rule, if the HDL code selected by the user refers to a signal that is created and then just abandoned in that portion of the HDL code, the CAD tool can assume that the signal is a primary output. The implied legality function performed by the CAD tool disclosed herein for implied output ports is different than the traditional behavior of a previously known CAD tool that would delete any portion of logic that is never consumed to conserve logic resources on the IC.

As another example of an implied legality function, the CAD tool can apply a rule for the implied signal width of signals in the HDL code selected by the user for synthesis (e.g., in interface 101). According to this rule, if the HDL code selected by the user refers to a signal, the CAD tool disclosed herein assumes that the signal has been legally defined in the remainder of the HDL code, or is otherwise legal according to the syntax rules of the HDL code.

For example, a Verilog signal can be referred to simply by name (e.g., foo) or by a bit selection of a whole or part of the signal (e.g., foo[7:0]). Typically, a user makes the size of each signal clear in a declaration in the HDL code (e.g., wire foo[15:0]). According to the syntax of the HDL code, it may be permissible to have a signal in which the least significant bit is a value other than 0.

According to the implied signal width rule, the CAD tool forgoes signal declarations and infers the width of signals in the HDL code selected by the user (e.g., in interface 101). If a signal in the selected HDL code includes a range of signals (e.g., foo[7:3]), then the CAD tool assumes that the full range of signals exists (e.g., foo bits [7:0]). If the signal is used in the HDL code such that a signal width other than a specific signal width would cause minimizations, the CAD tool assumes that the signal is fully provisioned (e.g., foo[7:0]==bar). In this example, the expression foo[7:0]==bar can be used if bar is also declared with a [7:0] signal range. Although other signal widths are legal for many types of HDL code, many types of signal widths in HDL code are likely to be designer errors.

As another example of an implied legality function, the CAD tool can apply a rule for the implied registers in the HDL code selected by the user for synthesis (e.g., in interface 101). Rather than requiring an explicit register declaration in the HDL code selected by the user, the CAD tool applies the implied register rule by determining how a signal in the selected HDL code is assigned and assumes the typical registering for that type of assignment. The CAD tool can generate new HDL code for the circuit design that implements an implied register and then automatically adds the new HDL code to the HDL code selected by the user for synthesis. The CAD tool can, for example, generate the new HDL code to provide the optimal balancing depth for each of the added registers within a logic cone.

In Verilog, there are two types of assignments. One type of assignment (e.g., designated by “=”) in Verilog is typically used for combinational nodes, and another type of assignment (e.g., designated by “<=”) in Verilog is typically used for registers. These assignment types do not exist in VHDL. Instead, the registers in VHDL are explicitly defined in a process.

According to another example of an implied legality function, the CAD tool can apply a rule for implied pipelines in the HDL code selected by the user for synthesis (e.g., in interface 101). Typically, high speed RTL constructions assume alternating layers of combinatorial logic (e.g., LUTs) and registers. As a simple example, the pipelined implementation of a N input combinatorial logic gate typically forms a logic tree having 6 input nodes, with a latency of about log₆ W, where W is the width to implement the expression. A traditional Verilog extraction requires latency (if any) to be explicit, so that the AND of 40 terms has zero associated latency. According to the implied pipelines rule, the CAD tool assumes a latency of 3 for this structure and distributes the latency appropriately.

The CAD tool can also apply the context of the other synthesis options. For example, the 6 input nodes in the example discussed above can overload the local routing if there are too many independent inputs into a LAB. The CAD tool can present other options to the user in interface 103, such as spreading the circuit design for the HDL code selected in interface 101 across multiple logic blocks (e.g., LABs).

According to another example of an implied legality function, the CAD tool can apply a rule during synthesis of the HDL code selected by the user (e.g., in interface 101) that does not require all of the syntax rules (e.g., synthesis rules) that are normally required for compilation of code written in the HDL. In this example, the CAD tool does not require that the syntax rules normally required by an HDL compiler be used in the HDL code selected by the user in interface 101, if the intent of the HDL code can be determined. As an example of a syntax rule, a Verilog compiler expects a semi-colon to terminate each expression in Verilog code.

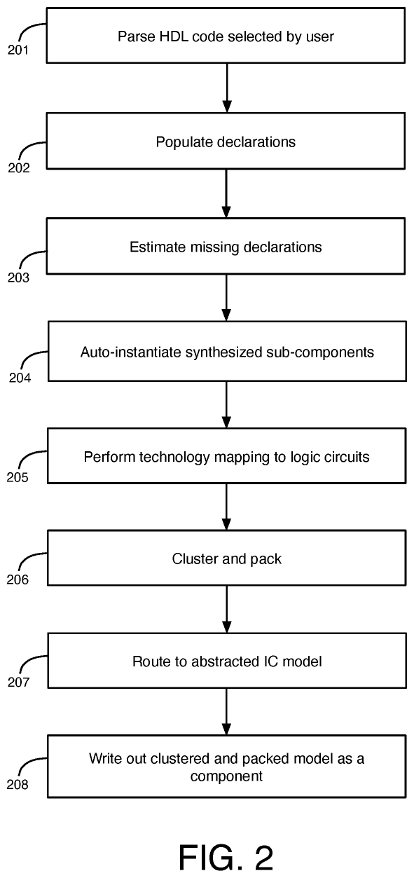

FIG. 2 depicts a flow chart that illustrates examples of operations that can be performed to synthesize a subset of the HDL code for a portion of a circuit design for an IC. In operation 201, the CAD tool parses the HDL code selected by the user (e.g., in interface 101 of GUI 100), which corresponds to only a portion of the circuit design for the IC. In operation 201, the CAD tool can, for example, parse the HDL code using recursive descent. In operation 202, the CAD tool populates the variable declarations in the HDL code selected by the user. If the HDL code selected by the user includes references to any variables that are not declared in any variable declarations within the HDL code selected by the user, the CAD tool estimates the missing variable declarations in operation 203 (e.g., by creating variable declarations for the missing variables). In operation 203, the CAD tool can also identify and correct any other errors in HDL code selected by the user.

In operation 204, the CAD tool identifies any sub-components of HDL code in the HDL code selected by the user that have already been synthesized (e.g., using a library of synthesized sub-components of HDL code) and automatically instantiates these sub-components of HDL code. The CAD tool instantiates any sub-components in the HDL code selected by the user that have been previously synthesized, instead of re-synthesizing these sub-components, whenever possible to reduce processing time and resources.

In operation 205, the CAD tool performs technology mapping of the HDL code selected by the user to logic circuits (e.g., to logic gates and lookup table circuits). The technology mapping can, for example, generate all possible outputs simultaneously, because the problem scope of the HDL code selected by the user is usually small. In operation 206, the CAD tool performs clustering and packing of the logic circuits generated in operation 205 (e.g., to logic array blocks or other blocks of logic circuits in the IC architecture) to generate a clustered and packed model of the circuit design. The clustering and packing operation 206 can also indicate the efficiency and utilization of the portion of the circuit design corresponding to the HDL code selected by the user.

In operation 207, the CAD tool routes the clustered and packed model of the circuit design generated in operation 206 to an abstracted model of the IC (e.g., a configurable IC) by selecting local and global routing resources in the IC to route signals in the portion of the circuit design. The CAD tool may, for example, generate exact information about the routing selected in the local routing resources in the IC. However, the CAD tool may only generate an average of the global routing resources to be used in the IC by the circuit design, because the exact global routing resources to be used by the entire circuit design depends on the location of the portion of the circuit design in the IC and the location of the remainder of the circuit design in the IC, which has not yet been fully routed.

In operation 208, the CAD tool writes out (i.e., outputs) the clustered and packed model of the circuit design that has been routed to the abstracted model of the IC as a component. The CAD tool outputs the clustered and packed model of the circuit design in operation 208 as a component, so that the clustered and packed model of the circuit design can be re-used with the exact same clustering, packing, and routing information at a later time (e.g., in the context of the entire circuit design). The output of operation 208 can allow the user to directly determine the impact of the user's design decisions.

In some exemplary implementations, the CAD tool can support a library of intellectual property (IP) blocks that are used, for example, in operation 204. The library includes HDL code for implementing each of the IP blocks. In these implementations, the CAD tool accesses HDL code for IP blocks referenced in the user selected HDL code from a library and adds the HDL code from the library to the user selected HDL code, rather than making assumptions about missing information in the user selected HDL code. The library of IP blocks can include, for example, simple expressions that represent a few lines of Verilog or VHDL expressions. As other examples, the library can include more elaborate expressions, such as instantiating another module. The CAD tool can also accept full child instance declarations. As a specific example, the CAD tool can display a complete and fully legal HDL circuit design accessed from the library in a helper window to the user in a GUI. The CAD tool can also display to the user a technology cell netlist that is generated from the circuit design.

As another example, the CAD tool can accept and modify approximate instantiations of child components in the user selected HDL code. A child instantiation of a component may include port connections, such as to clock and reset signals, that can cause errors during synthesis. For example, Verilog allows adding a pipelined child component and connecting the clock input of the child component to 0. The child component will be stuck at 0 and will subsequently be minimized away by the CAD tool. A component with a clock input connected to 0 is most likely an unintentional error on the part of the designer. In this example, the CAD tool can assume that the clock input is coupled to the clock signal in the surrounding logic and modify the HDL code accordingly to couple the clock input of the component to the clock signal.

As another example, the CAD tool can infer the creation of any components in the user selected HDL code that can be determined from the names of the components. For example, if the HDL code instantiates a small Ethernet core, the CAD tool searches for a generatable component with the same name as the Ethernet core in the IP library. If the CAD tool locates a component in the IP library with the same name as the Ethernet core, then the CAD tool adds the HDL code for the component located in the IP library to the user selected HDL code, rather than outputting an error message. The CAD tool can display the location and path to the component located in the IP library to the user so that the user can verify that a known component has been added to the HDL code. Alternately, the CAD tool can scan the entire file of the HDL code for a declared core declaration. As declarations are often contained in included files (such as VHDL package files), an additional file type can be defined for the CAD tool, which describes the folders and paths of the entire project for the circuit design, and that is separate from the project files used by the full synthesis flow.

Previously known CAD tools for designing circuit designs for ICs typically require additional input in the form of location constraints for logic and pins, voltage and termination standards to use, floor-planning regions, timing expectations for the whole or specific exception paths, and optimization techniques to enable or disable. Previously known CAD tools have a very narrow interpretation of legal HDL code, in that these CAD tools compile HDL code exactly as written and halt upon identifying any error. Previously known CAD tools usually interpret the absence of a constraint for a parameter in HDL code as the absence of any requirement for that parameter.

According to various examples, the CAD tool disclosed herein can infer a likely intent of a circuit design from HDL code provided by a user, and then the CAD tool can add HDL code automatically as needed for any missing information in the HDL code provided by the user (i.e., containing an error of omission) to perform the synthesis operation. With this feature, the CAD tool can process HDL code that is written by a user in an exploratory manner. The CAD tool can, for example, provide the user with an option 107 (or an option in interface 103) in GUI 100 shown in FIG. 1 to place the CAD tool in an early design exploration mode that enables a set of helpful relaxations of the normal rules applied by an HDL compiler. The CAD tool can also provide the user with an option 108 in GUI 100 shown in FIG. 1 to place the CAD tool in a production mode, in which the normal rules are applied by the HDL compiler. Either of these modes can be a default mode applied by the CAD tool in the absence of input from the user.

When the CAD tool is in the early design exploration mode (e.g., by selecting option 107), the CAD tool can add reasonable design constraints to the HDL code. For example, if the CAD tool identifies the absence of power or speed requirements for the top level circuit design in the HDL code as an error of omission, the CAD tool can add a power or speed requirement to the HDL code that is typically used for current field deployments of the IC. The CAD tool makes assumptions to use a typical constraint based on a likely user intent, rather than treating the absence of a constraint for a parameter in the HDL code as not having any constraints for the parameter. The CAD tool can display in interface 106 the assumptions made by the CAD tool regarding, for example, timing, power, voltage, routing, wiring, and floorplan constraints. The CAD tool can also suggest settings for the HDL code to the user. This feature may be helpful for users who are new to the IC technology and are unaware of the need to set expectations and/or the HDL syntax.

It is relatively common for experienced circuit designers to accidentally omit a timing exception on a signal path in HDL code for a circuit design for an IC. Often, signal paths with omitted timing exceptions tend to have idiosyncratic structure in the circuitry. For example, when a signal crosses between clock domains, HDL code may be written to include a register in one clock domain that feeds 2 or more registers with no logic circuits in another clock domain, which is a metastability recovery structure. Typically, an HDL compiler requires that a timing constraint be entered in a separate file noting that the signal crossing between clock domains is not required to satisfy a typical timing relationship, which may be impossible to achieve in the circuit design. Previously known CAD tools try to satisfy a timing relationship when a timing constraint is omitted for a signal path and generate an error message if unsuccessful.

As another example, the CAD tool disclosed herein can identify any circuit patterns or signal paths in the HDL code that lack timing constraints or exceptions to timing constraints (i.e., identify errors of omission), add to the HDL code a temporary timing constraint or an exception to a previously entered timing constraint, and suggest the added timing constraint or exception to the user for future runs of the HDL code. The CAD tool can, for example, suggest adding a timing constraint, an exception to a previously entered timing constraint, or a power constraint in an interface 105 in GUI 100 of FIG. 1 for the future runs of the HDL code. The CAD tool can, for example, add an exception to a timing constraint to the HDL code and suggest to the user the exception to the timing constraint for any signal path that cannot satisfy the timing constraint.

Many types of ICs have input/output (IO) pins that only support one voltage standard. Previously known CAD tools stop the compilation of HDL code and generate an error message in response to an omitted voltage constraint for an IO pin. According to yet another example, the CAD tool disclosed herein can instead identify any IO pin lacking a voltage constraint in HDL code as an error of omission and assume that the IO pin was intended by the user to have a non-default voltage setting that would make the arrangement of the IO pin in the circuit design for the IC legal according to the voltage standards supported by the IC for that IO pin. The CAD tool disclosed herein can display the assumption for the voltage setting or constraint to the user in interface 106.

In some circuit designs for an IC, a user adds a request in HDL code for a specific cell (e.g., set of logic circuits) to be placed at a particular location in the IC that cannot be honored by the HDL compiler, because the request conflicts with another requirement, or because the request contains an error. In early design exploration mode, the CAD tool disclosed herein can ignore such a request or change the request (i.e., identify the request as an error of commission) and place the cell in a nearby legal location in the IC, rather than halting the compilation and generating an error message.

In some circuit designs for an IC, a user may draw a rectangle in a layout for the IC to indicate a desired location of logic circuitry. While the circuit design is under construction, it is common for the rectangle to end up being too small to accommodate the logic circuitry. Previously known CAD tools attempt to fit the logic circuitry into the rectangle drawn by the user, which can be time consuming, and then report an error to the user if unsuccessful.

In early design exploration mode, the CAD tool disclosed herein can identify the layout area drawn by a user for fitting logic circuitry in the floorplan of an IC (as defined in HDL code) as an error of commission (e.g., for being too small), expand the layout area as needed, and report a suggestion to the user to change the size of the layout area in the HDL code. The CAD tool can, for example, generate the suggestion in interface 105 in GUI 100 of FIG. 1 to change the layout area for fitting logic circuitry (e.g., defined by a rectangle) in an IC that is defined in HDL code for the future runs of the HDL code. The CAD tool can display any assumptions made regarding floorplan constraints of the IC to the user in interface 106.

When creating circuit designs for ICs, often users perform circuit design exploration including compilation with no intention of fabricating a compiled circuit design in a physical IC die. Previously known CAD tools often spend a substantial amount of runtime generating a very detailed solution of a circuit design for an IC (e.g., embodied in a bitstream loadable onto a board for a configurable IC), even if the circuit design is incomplete and not functional. For example, if a user does not specify a detailed clocking solution in a circuit design, the compiled circuit design may not function properly in an IC. If a user can indicate that the intention is, for example, to establish the resource costs of an assembly of a circuit design, there is no need to spend CAD tool runtime on detailed speed optimizations (e.g., which can amount to half of the compile time).

As discussed above, the CAD tool disclosed herein can provide a user with an option 107 of functioning in an early design exploration mode. In response to the user selecting option 107 in GUI 100 to enter the early design exploration mode, the CAD tool can perform a limited synthesis of the HDL code selected by the user, while skipping some of the operations normally performed during synthesis of a circuit design for an IC. The CAD tool can, for example, perform very detailed operations to provide a user with information about a synthesized circuit design quickly and accurately in the early design exploration mode, while skipping over any synthesis operations that are not required. This feature allows a user to receive information about a partially synthesized circuit design, without the user needing to understand precisely what the synthesis rules and operations are for and what synthesis rules and operations can and cannot be omitted.

The CAD tool disclosed herein can use a set of predefined rules to identify patterns and relationships in the HDL code. These rules can be based on mathematical formulas, geometry, and other principles that the CAD tool has been programmed to recognize. The CAD tool can use heuristics to make educated guesses about the most likely solution. For example, if the HDL code suggests that certain dimensions are related in a specific way, the CAD tool can use this information to make assumptions about other dimensions. The CAD tool can use inference to draw conclusions from the HDL code. This inference involves using logical reasoning to make deductions based on the available information. The CAD tool can use optimization algorithms to find the most efficient solution that meets the given constraints by evaluating a large number of possible solutions and selecting the best one based on specific criteria.

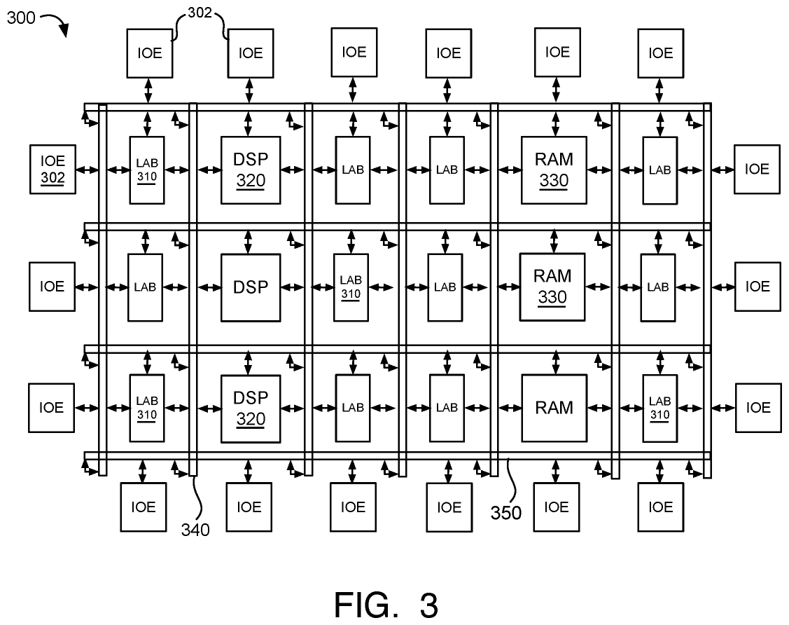

FIG. 3 illustrates an example of a programmable logic IC 300 that can implement techniques disclosed herein. As shown in FIG. 3, the programmable logic IC 300 includes a two-dimensional array of configurable functional circuit blocks, including configurable logic array blocks (LABs) 310 and other functional circuit blocks, such as random access memory (RAM) blocks 330 and digital signal processing (DSP) blocks 320. Functional blocks such as LABs 310 can include smaller programmable logic circuits (e.g., logic elements, logic blocks, or adaptive logic modules) that receive input signals and perform custom functions on the input signals to produce output signals.

In addition, programmable logic IC 300 can have input/output elements (IOEs) 302 for driving signals off of programmable logic IC 300 and for receiving signals from other devices. IOEs 302 may include parallel input/output circuitry, serial data transceiver circuitry, differential receiver and transmitter circuitry, or other circuitry used to connect one integrated circuit to another integrated circuit. As shown, IOEs 302 may be located around the periphery of the chip. If desired, the programmable logic IC 300 may have IOEs 302 arranged in different ways. For example, IOEs 302 may form one or more columns, rows, or islands of input/output elements that may be located anywhere on the programmable IC 300.

The programmable logic IC 300 can also include programmable interconnect circuitry in the form of vertical routing channels 340 (i.e., interconnects formed along a vertical axis of programmable logic IC 300) and horizontal routing channels 350 (i.e., interconnects formed along a horizontal axis of programmable logic IC 300), each routing channel including at least one track to route at least one wire.

Note that other routing topologies, besides the topology of the interconnect circuitry depicted in FIG. 3, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-2 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable logic IC 300 may contain programmable memory elements. Memory elements may be loaded with configuration data using IOEs 302. Once loaded, the memory elements each provide a corresponding static control signal that controls the operation of an associated configurable functional block (e.g., LABs 310, DSP blocks 320, RAM blocks 330, or IOEs 302).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable logic IC 300 may include configuration memory that is organized in sectors, whereby a sector may include the configuration RAM bits that specify the functions and/or interconnections of the subcomponents and wires in or crossing that sector. Each sector may include separate data and address registers.

The programmable IC of FIG. 3 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

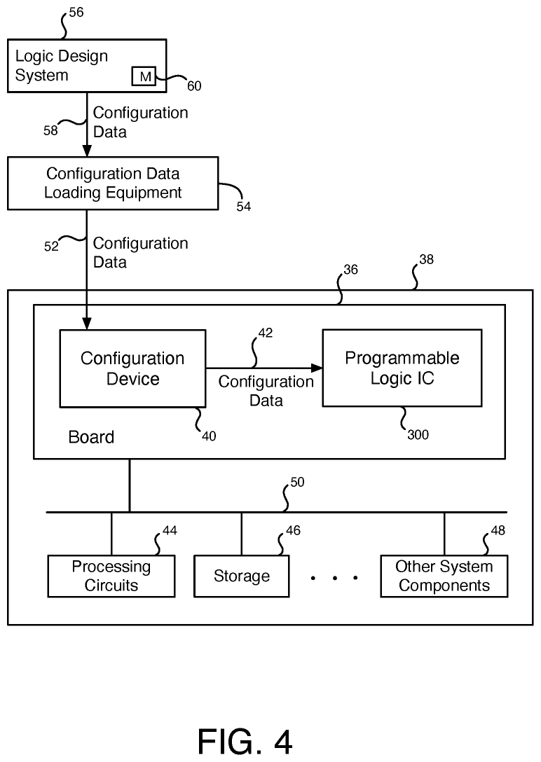

An illustrative system environment for IC 300 is shown in FIG. 4. IC 300 can be mounted on a board 36 in a system 38. In general, programmable logic IC 300 can receive configuration data from programming equipment or from other suitable equipment or device. In the example of FIG. 4, programmable IC 300 is a type of programmable logic device that receives configuration data from an associated configuration device 40. With this type of arrangement, configuration device 40 can, if desired, be mounted on the same board 36 as programmable logic IC 300.

Configuration device 40 can be an erasable-programmable read-only memory (EPROM) chip, a programmable logic device configuration data loading chip with built-in memory, or other suitable device. When system 38 boots up (or at another suitable time), the configuration data for configuring the programmable logic IC 300 can be supplied to the programmable logic IC 300 from device 40, as shown schematically by path 42. The configuration data that is supplied to the programmable logic IC 300 can be stored in the programmable logic IC 300 in its programmable memory elements.

System 38 can include processing circuits 44, storage 46, and other system components 48 that communicate with IC 300. The components of system 38 can be located on one or more boards such as board 36 or other suitable mounting structures or housings and can be interconnected by buses, traces, and other electrical paths 50.

Configuration device 40 can be supplied with the configuration data for IC 300 over a path, such as path 52. Configuration device 40 can, for example, receive the configuration data from configuration data loading equipment 54 or other suitable equipment that stores this data in configuration device 40. Device 40 can be loaded with data before or after installation on board 36.

In the example of FIG. 4, a logic design system 56 generates the configuration data. The configuration data produced by the logic design system 56 can be provided to equipment 54 over a path, such as path 58. The equipment 54 provides the configuration data to device 40, so that device 40 can later provide this configuration data to the programmable logic IC 300 over path 42. Logic design system 56 can be based on one or more computers and one or more software programs. In general, software and data may be stored on any computer-readable storage medium in system 56 and is shown schematically as storage 60 in FIG. 4.

In a typical scenario, logic design system 56 is used by a logic designer to create a circuit design for IC 300. The system 56 produces corresponding configuration data that is provided to configuration device 40. Upon power-up, configuration device 40 and data loading circuitry in programmable logic IC 300 are used to load the configuration data into the memory elements of IC 300. IC 300 can then be used in normal operation of system 38.

After IC 300 is initially loaded with a set of configuration data (e.g., using configuration device 40), IC 300 can be reconfigured by loading a different set of configuration data. Sometimes, it may be desirable to reconfigure only a portion of the memory elements in IC 300 via a process referred to as partial reconfiguration. As memory elements are typically arranged in an array, partial reconfiguration can be performed by writing new data values only into selected portion(s) in the array, while leaving portions of the array other than the selected portion(s) in their original state.

It can be a significant undertaking to design and implement a desired (custom) logic circuit design in a programmable logic integrated circuit (IC). Logic designers therefore generally use logic design systems based on computer-aided-design (CAD) tools to assist them in designing circuits. A logic design system can help a logic designer design and test complex circuits for a system. When a design is complete, the logic design system can be used to generate configuration data for electrically programming the appropriate programmable logic IC.

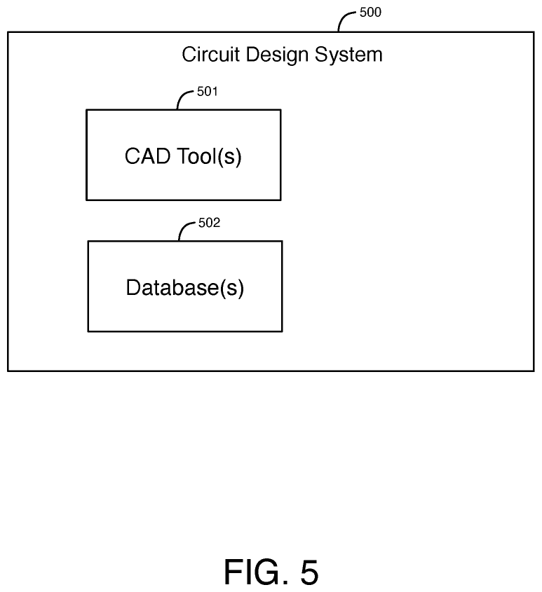

An illustrative circuit design system 500 in accordance with an embodiment is shown in FIG. 5. If desired, the circuit design system of FIG. 5 can be used in a logic design system such as logic design system 56 shown in FIG. 4. Circuit design system 500 can be implemented on integrated circuit design computing equipment. Circuit design system 500 can, for example, include one or more networked computer systems with processors, memory, mass storage, input/output devices, etc. System 500 can, for example, be based on one or more processors such as personal computers, workstations, etc. The processor(s) can be linked using a network (e.g., a local or wide area network). Memory in these computers or external memory and storage devices can be used to store instructions and data.

Software-based components such as computer-aided design (CAD) tool(s) 501 and database(s) 502 reside on system 500. During operation, executable software such as the software of computer aided design tool(s) 501 runs on the processor(s) of system 500. CAD tools 501 can include the CAD tool disclosed herein with respect to FIGS. 1-2. Database(s) 502 are used to store data for the operation of system 500. In general, software and data may be stored in non-transitory computer readable storage media (e.g., tangible computer readable storage media). The software code may sometimes be referred to as software, data, program instructions, instructions, or code. The non-transitory computer readable storage media may include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Software stored on the non-transitory computer readable storage media may be executed on system 500. When the software of system 500 is installed, the storage of system 500 has instructions and data that cause the computing equipment in system 500 to execute various methods (processes). When performing these processes, the computing equipment is configured to implement the functions of circuit design system 500.

The computer aided design (CAD) tool(s) 501, some or all of which are sometimes referred to collectively as a CAD tool, a circuit design tool, or an electronic design automation (EDA) tool, may be provided by a single vendor or by multiple vendors. Tool(s) 501 may be provided as one or more suites of tools (e.g., a compiler suite for performing tasks associated with implementing a circuit design in a programmable IC) and/or as one or more separate software components (tools). Database(s) 502 may include one or more databases that are accessed only by a particular tool or tools and may include one or more shared databases. Shared databases may be accessed by multiple tools. For example, a first tool may store data for a second tool in a shared database. The second tool may access the shared database to retrieve the data stored by the first tool. This allows one tool to pass information to another tool. Tools may also pass information between each other without storing information in a shared database if desired.

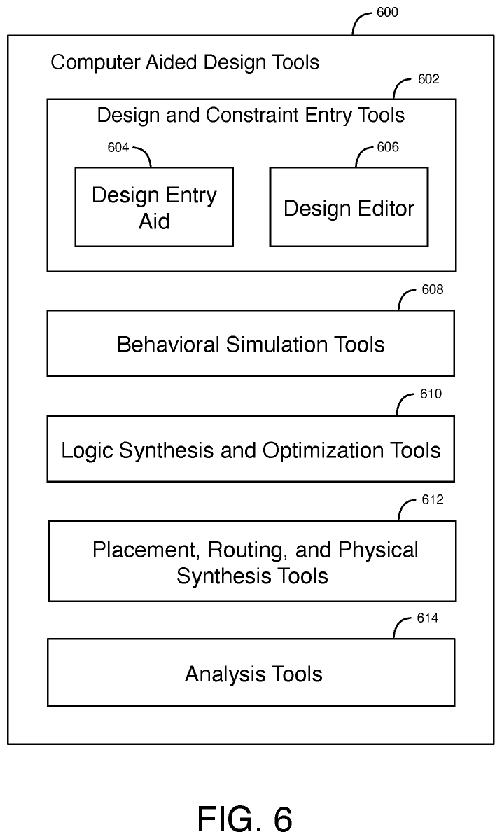

Illustrative computer aided design tools 600 that can be used in a circuit design system such as circuit design system 500 of FIG. 5 are shown in FIG. 6. The design process can start with the formulation of functional specifications of the integrated circuit design (e.g., a functional or behavioral description of the integrated circuit design). A circuit designer can specify the functional operation of a desired circuit design using design and constraint entry tools 602. Design and constraint entry tools 602 can include tools such as design and constraint entry aid 604 and design editor 606. Design and constraint entry aids such as aid 604 can be used to help a circuit designer locate a desired design from a library of existing circuit designs and can provide computer-aided assistance to the circuit designer for entering (specifying) the desired circuit design. Design and constraint entry tools 602 can allow a circuit designer to enter timing constraints for the desired circuit design through aid 604.

As an example, design and constraint entry aid 604 can be used to present screens of options for a user. The user can click on on-screen options to select whether the circuit being designed should have certain features. Design editor 606 can be used to enter a design (e.g., by entering lines of hardware description language code), can be used to edit a design obtained from a library (e.g., using a design and constraint entry aid), or can assist a user in selecting and editing appropriate prepackaged code/designs. The GUI disclosed herein with respect to FIG. 1 can be part of (e.g., generated by) the design entry aid 604.

Design and constraint entry tools 602 can be used to allow a circuit designer to provide a desired circuit design using any suitable format. For example, design and constraint entry tools 602 can include tools that allow the circuit designer to enter a circuit design using truth tables. Truth tables can be specified using text files or timing diagrams and can be imported from a library. Truth table circuit design and constraint entry can be used for a portion of a large circuit or for an entire circuit.

As another example, design and constraint entry tools 602 can include a schematic capture tool. A schematic capture tool can allow the circuit designer to visually construct integrated circuit designs from constituent parts such as logic gates and groups of logic gates. Libraries of preexisting integrated circuit designs can be used to allow a desired portion of a design to be imported with the schematic capture tools.

If desired, design and constraint entry tools 602 can allow the circuit designer to provide a circuit design to the circuit design system 500 using a hardware description language such as Verilog hardware description language (Verilog HDL), Very High Speed Integrated Circuit Hardware Description Language (VHDL), SystemVerilog, or a higher-level circuit description language such as OpenCL or SystemC, just to name a few. The designer of the integrated circuit design can enter the circuit design by writing hardware description language code with editor 606. Blocks of code can be imported from user-maintained or commercial libraries if desired.

After the circuit design has been entered using design and constraint entry tools 602, behavioral simulation tools 608 can be used to simulate the functionality of the circuit design. If the functionality of the design is incomplete or incorrect, the circuit designer can make changes to the circuit design using design and constraint entry tools 602. The functional operation of the new circuit design can be verified using behavioral simulation tools 608 before synthesis operations have been performed using tools 610. Simulation tools such as behavioral simulation tools 608 can also be used at other stages in the design flow if desired (e.g., after logic synthesis). The output of the behavioral simulation tools 608 can be provided to the circuit designer in any suitable format (e.g., truth tables, timing diagrams, etc.).

After the functional operation of the circuit design has been determined to be satisfactory, logic synthesis and optimization tools 610 can generate a gate-level netlist of the circuit design, for example, using gates from a particular library pertaining to a targeted process supported by a foundry that has been selected to produce the integrated circuit. Alternatively, logic synthesis and optimization tools 610 can generate a gate-level netlist of the circuit design using gates of a targeted programmable IC (i.e., in the logic and interconnect resources of a particular programmable IC product or product family).

Logic synthesis and optimization tools 610 can optimize the circuit design by making appropriate selections of hardware to implement different logic functions in the circuit design based on the circuit design data and constraint data entered by the logic designer using tools 602. As an example, logic synthesis and optimization tools 610 can perform multi-level logic optimization and technology mapping based on the length of a combinational path between registers in the circuit design and corresponding timing constraints that were entered by the logic designer using tools 602.

After logic synthesis and optimization using tools 610, the circuit design system 500 can use tools such as placement, routing, and physical synthesis tools 612 to perform physical design steps (layout synthesis operations). Tools 612 can be used to determine where to place each gate of the gate-level netlist produced by tools 610. For example, if two counters interact with each other, tools 612 may locate these counters in adjacent regions to reduce interconnect delays or to satisfy timing requirements specifying the maximum permitted interconnect delay. Tools 612 create orderly and efficient implementations of circuit designs for any targeted integrated circuit (e.g., for a given programmable integrated circuit such as a field-programmable gate array (FPGA)).

Tools such as tools 610 and 612 can be part of a compiler suite (e.g., part of a suite of compiler tools provided by a programmable IC vendor). After an implementation of the desired circuit design has been generated using tools 612, the implementation of the design can be analyzed and tested using analysis tools 614. For example, analysis tools 614 can include timing analysis tools, power analysis tools, or formal verification tools, just to name few.

After satisfactory optimization operations have been completed using tools 600 and depending on the targeted integrated circuit technology, tools 600 can produce a mask-level layout description of the integrated circuit or configuration data for programming the programmable logic IC.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is a method for processing code for a circuit design for an integrated circuit using a computer system, the method comprising: receiving at least a portion of the code for the circuit design for the integrated circuit, wherein the portion of the code comprises an error; making an assumption about the error using a computer aided design tool in the computer system; and generating a revised circuit design for the integrated circuit with the error corrected based on the assumption and based on the code using the computer aided design tool.

In Example 2, the method of Example 1 may optionally include, wherein the error comprises an error of omission in the code for the circuit design.

In Example 3, the method of any one of Examples 1-2 may optionally include, wherein the error comprises an error of commission in the code for the circuit design.

In Example 4, the method of any one of Examples 1-3 may optionally include, wherein receiving the portion of the code for the circuit design further comprising receiving only a portion of the code for the circuit design selected by a user that comprises the error in a graphical user interface generated by the computer aided design tool.

In Example 5, the method of any one of Examples 1-4 may optionally include, wherein making the assumption about the error in the code further comprises making the assumption about the error with regard to at least one of a timing constraint, a voltage constraint, a power constraint, a routing constraint, a wiring constraint, or a floorplan constraint for the integrated circuit.

In Example 6, the method of any one of Examples 1-5 may optionally include, wherein generating the revised circuit design further comprises generating the revised circuit design using first expressions in the code written in a first hardware description language and second expressions in the code written in a second hardware description language, and wherein the method further comprises compiling the revised circuit design with the first and the second expressions.

In Example 7, the method of any one of Examples 1-6 further comprises: generating a user interface that displays an output of the revised circuit design comprising revised code with the error corrected and assumptions made about the revised circuit design.

In Example 8, the method of any one of Examples 1-7 further comprises: performing a limited synthesis of the revised circuit design in an early design exploration mode that skips a subset of operations performed during a full synthesis to generate a netlist comprising logic circuits for the revised circuit design.

Example 9 is a non-transitory computer readable storage medium comprising instructions stored thereon for causing a computer system to process original code for a circuit design for an integrated circuit, wherein the instructions cause the computer system to: identify an error in the original code for the circuit design for the integrated circuit; correct the error in the original code to generate a correction for the error; and generate a revised circuit design for the integrated circuit comprising revised code that is based on the correction for the error and that is based on the original code.

In Example 10, the non-transitory computer readable storage medium of Example 9 may optionally include, wherein the instructions further cause the computer system to: correct the error with regard to at least one of an input port, an output port, a variable declaration, a signal width, a register, or an instantiation of a component in the circuit design for the integrated circuit to generate the correction.

In Example 11, the non-transitory computer readable storage medium of any one of Examples 9-10 may optionally include, wherein the instructions further cause the computer system to: synthesize the revised circuit design in an early design exploration mode that allows the revised circuit design to violate at least one synthesis rule.

In Example 12, the non-transitory computer readable storage medium of any one of Examples 9-11 may optionally include, wherein the instructions further cause the computer system to: provide a suggestion to a user for a change to the original code to correct the error in the original code.

In Example 13, the non-transitory computer readable storage medium of any one of Examples 9-12 may optionally include, wherein the instructions further cause the computer system to: identify a constraint that is lacking in the circuit design as an error of omission; and synthesize the revised circuit design using an assumption for the constraint.

In Example 14, the non-transitory computer readable storage medium of Example 13 may optionally include, wherein the constraint comprises at least one of a voltage constraint, a timing constraint, a power constraint, routing constraint, wiring constraint, or a layout constraint for the integrated circuit.

In Example 15, the non-transitory computer readable storage medium of any one of Examples 9-14 may optionally include, wherein the instructions further cause the computer system to: receive a selection from a user for a synthesis option that comprises at least one of a type of logic circuits, groupings of logic circuits, pipelining, locking a synthesis output, or a layout area in the integrated circuit; and synthesize the revised circuit design based on the selection from the user.

Example 16 is a computer system comprising a computer aided design tool, wherein the computer aided design tool is configured to: receive at least a portion of code for a circuit design for an integrated circuit, wherein the portion of the code comprises a violation of a rule; making an assumption that eliminates the violation of the rule from the code; and generate a revised circuit design for the integrated circuit based on the code with the violation of the rule eliminated using the assumption.

In Example 17, the computer system of Example 16 may optionally include, wherein the rule is a synthesis rule, and wherein the computer aided design tool is further configured to: synthesize the revised circuit design with the violation of the synthesis rule eliminated during an early design exploration mode.

In Example 18, the computer system of any one of Examples 16-17 may optionally include, wherein the computer aided design tool is further configured to: access additional code from a library of components for circuit designs based on an expression in the code for the circuit design; and generate the revised circuit design with the additional code from the library.

In Example 19, the computer system of any one of Examples 16-18 may optionally include, wherein the computer aided design tool is further configured to: identify the violation of the rule as an error of omission; and eliminate the violation of the rule by adding at least one of a voltage constraint, a timing constraint, a power constraint, a floorplan constraint, a routing constraint, an input port, an output port, a variable declaration, a signal width, a register, or an instantiation of a component to the revised circuit design.

In Example 20, the computer system of any one of Examples 16-19 may optionally include, wherein the computer aided design tool is further configured to: generate the revised circuit design using a first subset of the code written in a first hardware description language and a second subset of the code written in a second hardware description language; and synthesize the revised circuit design with the first and the second subsets of the code.

Example 21 is a computer system comprising a computer aided design tool, wherein the computer aided design tool is configured to: receive a portion of code for a circuit design for an integrated circuit selected by a user of the computer aided design tool; and synthesize the portion of the code selected by the user to logic resources of the integrated circuit to generate a synthesis output.

In Example 22, the computer system of Example 21 may optionally include, wherein the computer aided design tool is further configured to: provide the user with an option to select a processing type that comprises at least one of a library for the synthesis output, a gate for the synthesis output, a configurable circuit level for the synthesis output, or a logic circuit level for the synthesis output.

In Example 23, the computer system of any one of Examples 21-22 may optionally include, wherein the computer aided design tool is further configured to: synthesize the portion of the code in an early design exploration mode that allows a violation of at least one synthesis rule.

In Example 24, the computer system of any one of Examples 21-23 may optionally include, wherein the computer aided design tool is further configured to: provide a suggestion to the user for a change to the code to correct an error in the code.

In Example 25, the computer system of any one of Examples 21-24 may optionally include, wherein the computer aided design tool is further configured to: provide the user with an interface allowing selection of a synthesis option that comprises at least one of adding pipelining to the circuit design, locking the synthesis output to selected logic blocks, or spreading the portion of the code across multiple groups of logic circuits in the integrated circuit.

In Example 26, the computer system of any one of Examples 21-25 may optionally include, wherein the computer aided design tool is further configured to: generating an interface displaying a summary of the synthesis output comprising at least one of a number of gates, a number of configurable circuits, a number of wires, or a list of routes.

In Example 27, the computer system of any one of Examples 21-26 may optionally include, wherein the computer aided design tool is further configured to: receive a selection from the user for a synthesis option that comprises at least one of a type of logic circuits, groupings of logic circuits, pipelining, locking a synthesis output, or a layout area in the integrated circuit; and synthesize the portion of the code based on the selection from the user.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. A method for processing code for a circuit design for an integrated circuit using a computer system, the method comprising:
receiving at least a portion of the code for the circuit design for the integrated circuit, wherein the portion of the code comprises an error;
making an assumption about the error using a computer aided design tool in the computer system; and
generating a revised circuit design for the integrated circuit with the error corrected based on the assumption and based on the code using the computer aided design tool.

2. The method of claim 1, wherein the error comprises an error of omission in the code for the circuit design.

3. The method of claim 1, wherein the error comprises an error of commission in the code for the circuit design.

4. The method of claim 1, wherein receiving at least the portion of the code for the circuit design further comprises receiving only the portion of the code for the circuit design selected by a user that comprises the error in a graphical user interface generated by the computer aided design tool.

5. The method of claim 1, wherein making the assumption about the error further comprises making the assumption about the error with regard to at least one of a timing constraint, a voltage constraint, a power constraint, a routing constraint, a wiring constraint, or a floorplan constraint for the integrated circuit.

6. The method of claim 1, wherein generating the revised circuit design further comprises generating the revised circuit design using first expressions in the code written in a first hardware description language and second expressions in the code written in a second hardware description language, and wherein the method further comprises compiling the revised circuit design with the first and the second expressions.

7. The method of claim 1 further comprising:
generating a user interface that displays an output of revised code with the error corrected and constraints for the circuit design.

8. The method of claim 1 further comprising:
performing a limited synthesis of the revised circuit design in an early design exploration mode that skips a subset of operations performed during a full synthesis to generate a netlist comprising logic circuits for the revised circuit design.

9. A computer system comprising a computer aided design tool, wherein the computer aided design tool is configured to:
receive a portion of code for a circuit design for an integrated circuit selected by a user of the computer aided design tool; and
synthesize the portion of the code selected by the user to logic resources of the integrated circuit to generate a synthesis output.

10. The computer system of claim 9, wherein the computer aided design tool is further configured to:
provide the user with an option to select a processing type that comprises at least one of a library for the synthesis output, a gate for the synthesis output, a configurable circuit level for the synthesis output, or a logic circuit level for the synthesis output.

11. The computer system of claim 9, wherein the computer aided design tool is further configured to:
synthesize the portion of the code in an early design exploration mode that allows a violation of at least one synthesis rule.

12. The computer system of claim 9, wherein the computer aided design tool is further configured to:
provide a suggestion to the user for a change to the code to correct an error in the code.

13. The computer system of claim 9, wherein the computer aided design tool is further configured to:
provide the user with an interface allowing selection of a synthesis option that comprises at least one of adding pipelining to the circuit design, locking the synthesis output to selected logic blocks, or spreading the portion of the code across multiple groups of logic circuits in the integrated circuit.

14. The computer system of claim 9, wherein the computer aided design tool is further configured to:
generate an interface displaying a summary of the synthesis output comprising at least one of a number of gates, a number of configurable circuits, a number of wires, or a list of routes.

15. The computer system of claim 9, wherein the computer aided design tool is further configured to:
receive a selection from the user for a synthesis option that comprises at least one of a type of logic circuitry, groupings of logic circuits, pipelining, locking the synthesis output, or a layout area in the integrated circuit; and
synthesize the portion of the code based on the selection from the user.

16. A computer system comprising a computer aided design tool, wherein the computer aided design tool is configured to:
receive at least a portion of code for a circuit design for an integrated circuit, wherein the portion of the code comprises a violation of a rule;
making an assumption that eliminates the violation of the rule from the code; and
generate a revised circuit design for the integrated circuit based on the code with the violation of the rule eliminated using the assumption.

17. The computer system of claim 16, wherein the rule is a synthesis rule, and wherein the computer aided design tool is further configured to:
synthesize the revised circuit design with the violation of the synthesis rule eliminated during an early design exploration mode.

18. The computer system of claim 16, wherein the computer aided design tool is further configured to:
access additional code from a library of components for circuit designs based on an expression in the code for the circuit design; and
generate the revised circuit design with the additional code from the library.

19. The computer system of claim 16, wherein the computer aided design tool is further configured to:
identify the violation of the rule as an error of omission; and
eliminate the violation of the rule by adding at least one of a voltage constraint, a timing constraint, a power constraint, a floorplan constraint, a routing constraint, a wiring constraint, an input port, an output port, a variable declaration, a signal width, a register, or an instantiation of a component to the revised circuit design.

20. The computer system of claim 16, wherein the computer aided design tool is further configured to:
generate the revised circuit design using a first subset of the code written in a first hardware description language and a second subset of the code written in a second hardware description language; and
synthesize the revised circuit design with the first and the second subsets of the code.
